(19) United States
(12) Patent Application Publication
(10) Pub. No.: US 2012/0311675 A1
(43) Pub. Date: Dec. 6, 2012

(54) APPARATUS AND METHOD FOR GENERATING AND INSTALLING APPLICATION FOR DEVICE IN APPLICATION DEVELOPMENT SYSTEM

(75) Inventors: Dong-Eup HAM, Suwon-si (KR); Jung-Min CHO, Seoul (KR)

(73) Assignee: Samsung Electronics Co., Ltd., Suwon-si (KR)

(21) Appl. No.: 13/456,933

(22) Filed: Apr. 26, 2012

(30) Foreign Application Priority Data
Jun. 2, 2011 (KR) 10-2011-0053439

(51) Int. Cl. G06F 9/445; G06F 21/00

(52) U.S. Cl. 726/4; 717/176

(57) ABSTRACT

An operating method of a device for installing an application for a device includes receiving an application installation request including an application and an authentication token from an application development apparatus, and installing the application based on the authentication token, which includes serial numbers of devices authorized for the application.

### PRIORITY

The present application claims priority under 35 U.S.C. §119(a) to a Korean patent application filed in the Korean Intellectual Property Office on Jun. 2, 2011, and assigned Serial No. 10-2011-0053439, the contents of which are incorporated herein by reference.

### BACKGROUND OF THE INVENTION

1. Field of the Invention

The present invention relates generally to an application development system, and more particularly, to an apparatus and a method for generating and installing an application for a device in the application development system.

2. Description of the Related Art

Users of devices including mobile phones continue to demand various additional services as the mobile communication technology advances. To respond to this demand, mobile communication service providers are developing diverse additional services applicable to the devices.

To develop an application for the device for the application service, a conventional development method utilizes a Personal Computer (PC) simulator environment, a PC emulator environment, or a device environment of a particular model with a installed development tool, such as an Integrated Development Environment (IDE).

However, in this conventional development method, due to the difference between the development environment of the application for the device and the actual device environment for executing the additional service according to the application for the device, the additional service normally operating in the development environment is frequently subject to abnormal termination or symptoms in the device.

In this regard, the conventional development method first tests the developed application for the device in the development environment, and then obligatorily tests the device of device models to which the additional service according to the application developed for the device is serviced.

However, according to the conventional development method, when the application for the device is developed and tested, only one last application is deemed secure. As a result, a number of devices are required to simultaneously test several applications, during which time communication between two applications renders the testing difficult to perform.

### SUMMARY OF THE INVENTION

To address the above-discussed deficiencies of the prior art, an aspect of the present invention is to provide an apparatus and a method for generating and installing an application for a device in an application development system.

An aspect of the present invention is to provide an apparatus and a method for preventing illegal copies of an application by installing the corresponding application only to a device authorized for an application for a device in an application development system.

An aspect of the present invention is to provide an apparatus and a method for an application development apparatus to register a device serial number list authorized for an application for a device, to a development server, and for the development server to generate and transmit an authentication token and an application execution file based on the list in an application development system.

An aspect of the present invention is to provide an apparatus and a method for an application development apparatus to modify a device serial number list pre-registered to a development server, and for the development server to generate and transmit a new authentication token based on the modified list in an application development system.

An aspect of the present invention is to provide an apparatus and a method for a device to install an application based on an authentication token in an application development system.

According to the present invention, an operating method of a device for installing an application for a device includes receiving an application installation request including an application and an authentication token from an application development apparatus, and installing the application based on the authentication token, which includes serial numbers of devices authorized for the application.

According to the present invention, an operating method of an application development apparatus for installing an application for a device includes transmitting a serial number list of devices authorized for an application, to a development server, downloading an authentication token generated based on the device serial number list, from the development server, and transmitting an application installation request including the downloaded authentication token and an application to a device.

According to the present invention, an operating method of a development server for installing an application for a device includes receiving a serial number list of devices authorized for an application, from an application development apparatus, generating an authentication token based on the device serial number list, and transmitting the generated authentication token to the application development apparatus.

According to the present invention, a device for installing an application for a device includes a reception module for receiving an application installation request including an application and an authentication token from an application development apparatus, and a device application manager for installing the application based on the authentication token, which includes serial numbers of devices authorized for the application.

According to the present invention, an application development apparatus for installing an application for a device includes a transmission module for transmitting a serial number list of devices authorized for an application, to a development server, and a device application manager for downloading an authentication token generated based on the device serial number list, from the development server. The transmission module transmits an application installation request including the downloaded authentication token and an application to a device.

According to the present invention, a development server for installing an application for a device includes a reception module for receiving a serial number list of devices authorized for an application, from an application development apparatus, a device application manager for generating an authentication token based on the device serial number list, and a transmission module for transmitting the generated authentication token to the application development apparatus.

### BRIEF DESCRIPTION OF THE DRAWINGS

The above and other aspects, features, and advantages of embodiments of the present invention will be more apparent from the following description taken in conjunction with the accompanying drawings, in which:

FIG. 1 illustrates an application development system according to the present invention;

FIG. 2 illustrates a method for an application development apparatus to register a device serial number list to a development server, and for the development server to generate and transmit an authentication token and an application execution file based on the list, according to the present invention;

FIG. 3 illustrates a method for the application development apparatus to modify the device serial number list, and for the development server to generate and transmit a new authentication token based on the modified list according to the present invention;

FIG. 4 illustrates a method of the application development apparatus for registering the device serial number list to the development server, and downloading the authentication token generated based on the list and the application execution file from the development server according to the present invention;

FIG. 5 illustrates a development server for registering the device serial number list authorized for the application for the device, and generating and transmitting the authentication token and the application execution file based on the list according to the present invention;

FIG. 6 illustrates a method for installing the application based on the authentication token in the device according to the present invention;

FIG. 7 illustrates a method of the device for installing the application based on the authentication token according to the present invention; and

FIG. 8 illustrates the device (or the application development apparatus or the development server) according to the present invention.

Throughout the drawings, like reference numerals will be understood to refer to like parts, components and structures.

### DETAILED DESCRIPTION OF EMBODIMENTS OF THE INVENTION

The following description with reference to the accompanying drawings is provided to assist in a comprehensive understanding of embodiments of the invention as defined by the claims and their equivalents. Those of ordinary skill in the art will recognize that various changes and modifications of the embodiments described herein can be made without departing from the scope and spirit of the invention. In addition, descriptions of well-known functions and constructions may be omitted for the sake of clarity and conciseness.

Embodiments of the present invention provide a method for generating and installing an application for a device in an application development system.

Hereinafter, the device is a terminal capable of installing an application. The device can employ various information communication devices and multimedia devices such as a mobile communication terminal having a communication function, mobile phone, digital broadcasting terminal, Personal Digital Assistants (PDA), smart phone, International Mobile Telecommunication (IMT)-1200 terminal, Code Division Multiple Access (CDMA) terminal, Global Standard for Mobile communication (GSM) terminal, Wideband Code Division Multiple Access (WCDMA) terminal, High Speed Downlink Packet Access (HSDPA) terminal, Worldwide Interoperability for Microwave Access (WiMAX) terminal, and Universal Mobile Telecommunication Service (UMTS) terminal.

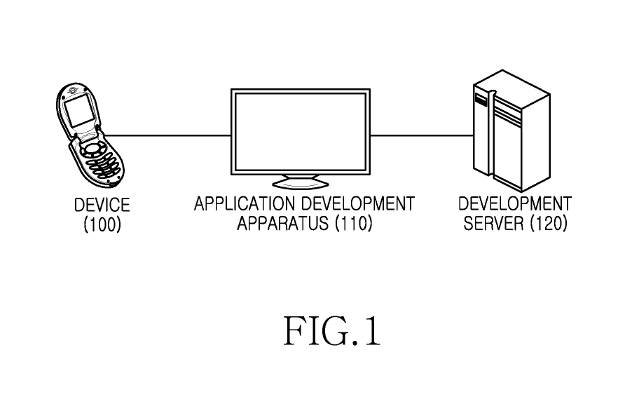

FIG. 1 illustrates an application development system according to the present invention.

The application development system includes a device 100, an application development apparatus 110, and a development server 120.

Referring to FIG. 1, the device 100 installs and executes a corresponding application based on the application and an authentication token Auto Token provided from the application development apparatus 110.

The application development apparatus 110 is a Personal Computer (PC) installing a dedicated development tool, such as an IDE. The application development apparatus 110 develops an application for the device, and controls to install and test the developed application. In particular, the dedicated development tool of the application development apparatus 110 registers a serial number list of devices authorized for the application for the device, to the development server 120, and downloads the authentication token generated based on the list and an application execution file (e.g., Manifest file) from the development server 120. The dedicated development tool of the application development apparatus 110 generates an application based on the downloaded authentication token and application execution file, and provides the generated application and the authentication token to the device 100 to control the installation of the application.

The development server 120 registers the serial number list of the devices authorized for the application for the device according to a request of the application development apparatus 110, generates the authentication token based on the list and the application execution file required to install the application for the device, and provides the authentication token and the application execution file to the application development apparatus 110. The application execution file includes an application identifier and an application profile, and the authentication token includes a signature, the application identifier, and the device serial number list.

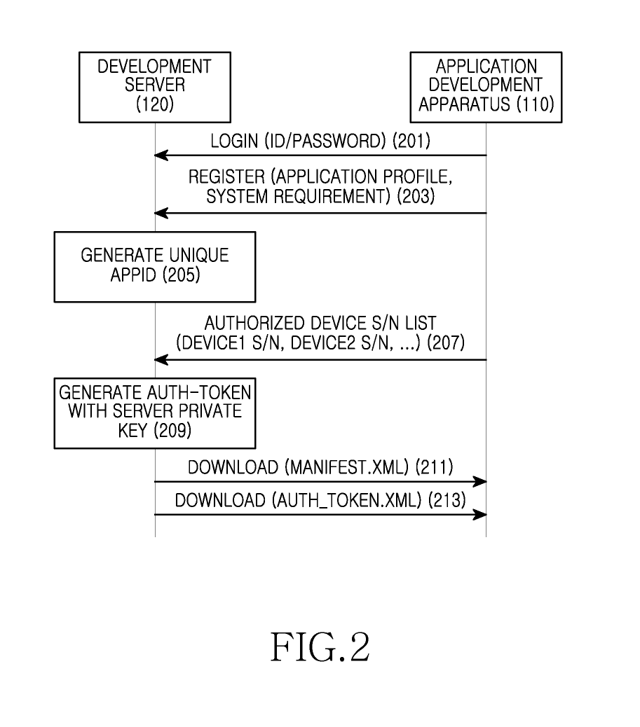

FIG. 2 illustrates a method for the application development apparatus to register the device serial number list authorized for the application for the device, to the development server, and for the development server to generate and transmit the authentication token and the application execution file based on the list, according to the present invention.

Referring to FIG. 2, the application development apparatus 110 logs in to the development server 120 by sending an IDentifier (ID) and a password to the development server 120 in step 201.

The application development apparatus 110 successfully completing the login to the development server 120 transmits a registration request including the application profile of the application to be generated and a system requirement to the development server 120 in step 203. The development server 120 receiving the registration request generates a unique application identifier in step 205, and maps, registers, and stores the generated application identifier with the application profile and the system requirement.

The application development apparatus 110 sends the serial number list of the devices authorized for the corresponding application to the development server 120 in step 207. The development server 120 receiving the device serial number list maps and stores the device serial number list with the generated application identifier, and generates the authentication token including the signature generated based on a server private key, the application identifier, and the device serial number list in step 209.

The authentication token is constructed in the format shown in Table 1.

TABLE 1

| Parameter | Description |
|---|---|
| AppID | 10 bytes unique application identification |
| numValue | count of <SerialNumber> |
| SerialNumber | 28 bytes unique device identification (base64 encoded) |
| Signature | Signature value for <AppID> and <SerialNumber> |
| | using Server Private Key |
| Certificate | Signer certificate and CA (Certificate Authority) |

The authentication token includes an application ID field (AppID) for identifying the application, a device number field (numValue) indicating the number of the devices authorized for the application, a device serial number field (SerialNumber) indicating the serial number list of the devices authorized for the application, a signature field (Signature) of the development server to block a malicious user from changing the fields (i.e., the AppID field, the numValue field, and the SerialNumber field), and a certificate chain (e.g., signer certificate, Certificate Authority (CA) certificate) field (Certificate) for signature verification.

The development server 120 generates and transmits the application execution file including the application identifier and the application profile to the application development apparatus 110 in step 211, and transmits the authentication token including the signature, the application identifier, and the device serial number list to the application development apparatus 110 in step 213. Hence, the application development apparatus 110 can generate the application based on the application execution file and the authentication token.

The application development apparatus initially registers the device serial number list to the development server and thus downloads the authentication token. Yet, when the intended device is added or released, the device serial number list is changed. In this case, it is necessary to download a new authentication token generated based on the changed device serial number list.

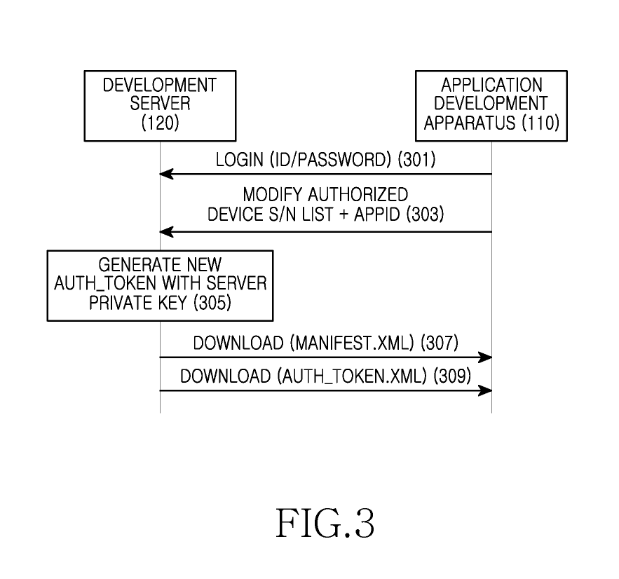

FIG. 3 illustrates a method for the application development apparatus to modify the device serial number list pre-registered to the development server, and for the development server to generate and transmit a new authentication token based on the modified list according to the present invention.

Referring to FIG. 3, the application development apparatus 110 logs in to the development server 120 by sending the ID and the password to the development server 120 in step 301.

In step 303, the application development apparatus 110 successfully completing the login to the development server 120 transmits the pre-registered application identifier and the modified device serial number list to the development server 120.

The development server 120 receiving the pre-registered application identifier and the modified device serial number list, maps and stores the modified device serial number list with the application identifier, and generates a new authentication token including the signature based on the server private key, the application identifier, and the modified device serial number list in step 305.

In step 307, the development server 120 generates the application execution file including the pre-registered application identifier and the application profile and transmits the generated application execution file to the application development apparatus 110.

In step 309, the development server 120 transmits the new authentication token including the signature, the pre-registered application identifier, and the modified device serial number list to the application development apparatus 110. Thus, the application development apparatus 110 can generate the application based on the application execution file and the new authentication token.

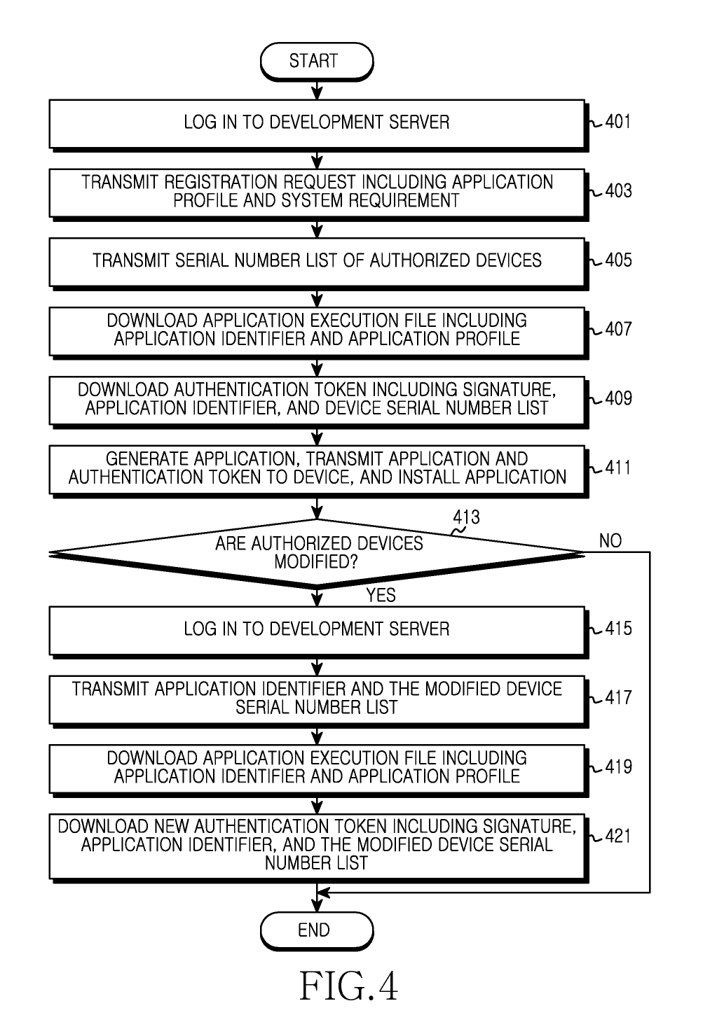

FIG. 4 illustrates a method of the application development apparatus for registering the device serial number list authorized for the application for the device, to the development server, and downloading the authentication token generated based on the list and the application execution file from the development server according to the present invention.

Referring to FIG. 4, the application development apparatus logs in to the development server by sending the ID and the password to the development server in step 401.

In step 403, the application development apparatus successfully completing the login to the development server transmits the registration request including the profile of the application to generate and the system requirement to the development server.

In step 405, the application development apparatus transmits the serial number list of the devices authorized for the application, to the development server.

In step 407, the application development apparatus downloads the application execution file including the application identifier and the application profile from the development server.

In step 409, the application development apparatus downloads the authentication token including the signature, the application identifier, and the device serial number list from the development server.

In step 411, the application development apparatus generates the application based on the downloaded application execution file and authentication token, and transmits the generated application and the authentication token to the device to install the application.

In step 413, the application development apparatus determines whether the devices authorized for the application are modified (i.e., added or released).

When the devices authorized for the application are modified in step 413, the application development apparatus logs in to the development server in step 415 and transmits the pre-registered application identifier and the modified device serial number list to the development server in step 417.

The application development apparatus downloads the application execution file including the pre-registered application identifier and the application profile from the development server in step 419, and downloads the new authentication token including the signature, the pre-registered application identifier, and the modified device serial number list in step 421.

By contrast, when the devices authorized for the application are not modified in step 413, the application development apparatus finishes this process.

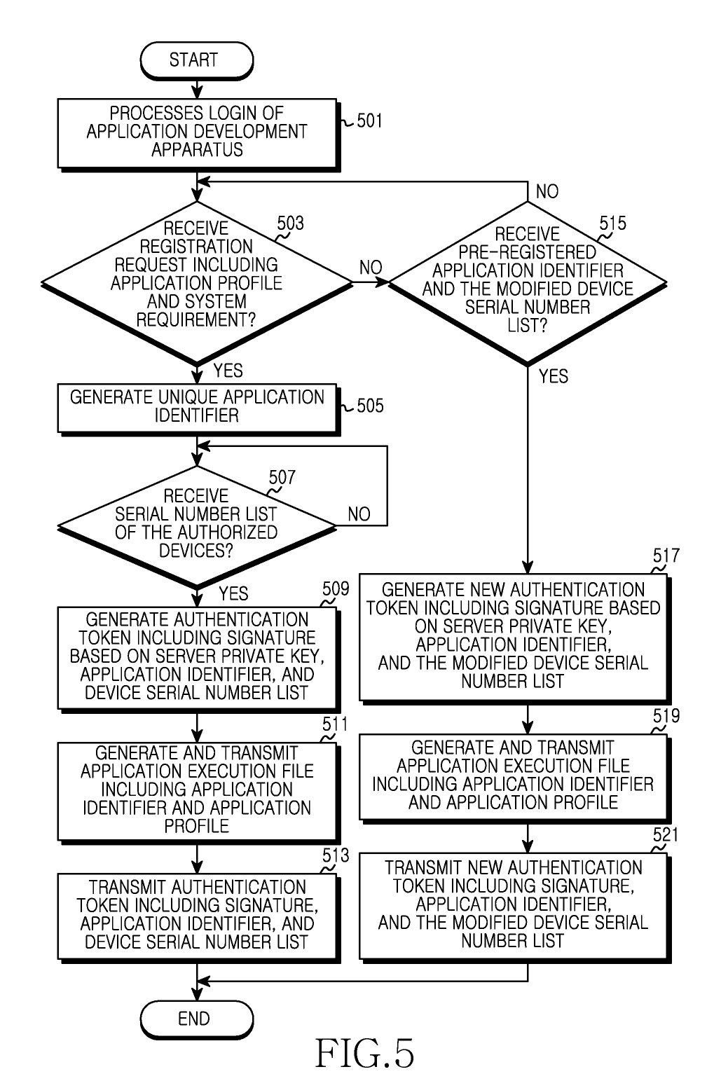

FIG. 5 illustrates the development server for registering the device serial number list authorized for the application for the device according to a request of the application development apparatus, and generating and transmitting the authentication token and the application execution file based on the list according to the present invention.

Referring to FIG. 5, the development server processes the login of the application development apparatus by receiving the ID and the password from the application development apparatus in step 501.

In step 503, the development server successfully completing the login of the application development apparatus, determines whether the registration request including the application profile of the application to be generated and the system requirement is received from the application development apparatus.

When receiving the registration request including the application profile of the application to be generated and the system requirement from the application development apparatus in step 503, the development server generates the unique application identifier, and maps and registers the generated application identifier with the application profile and the system requirement in step 505.

In step 507, the development server determines whether the serial number list of the devices authorized for the application is received from the application development apparatus.

When receiving the serial number list of the authorized devices from the application development apparatus in step 507, the development server maps and stores the device serial number list with the generated application identifier, and generates the authentication token including the signature based on the server private key, the application identifier, and the device serial number list in step 509.

In step 511, the development server generates the application execution file including the application identifier and the application profile, and transmits the generated application execution file to the application development apparatus.

In step 513, the development server transmits the authentication token including the signature, the application identifier, and the device serial number list to the application development apparatus.

By contrast, when the registration request including the application profile of the application to be generated and the system requirement from the application development apparatus is not received in step 503, the development server determines whether the pre-registered application identifier and the modified device serial number list are received from the application development apparatus in step 515.

When the pre-registered application identifier and the modified device serial number list from the application development apparatus are received in step 515, the development server maps and stores the modified device serial number list with the application identifier, and generates a new authentication token including the signature based on the server private key, the application identifier, and the modified device serial number list in step 517.

In step 519, the development server generates the application execution file including the pre-registered application identifier and the application profile, and transmits the generated application execution file to the application development apparatus.

In step 521, the development server transmits the new authentication token including the signature, the pre-registered application identifier, and the modified device serial number list to the application development apparatus.

By contrast, when the pre-registered application identifier and the modified device serial number list from the application development apparatus is not received in step 515, the development server returns to step 503.

Next, the development server finishes this process.

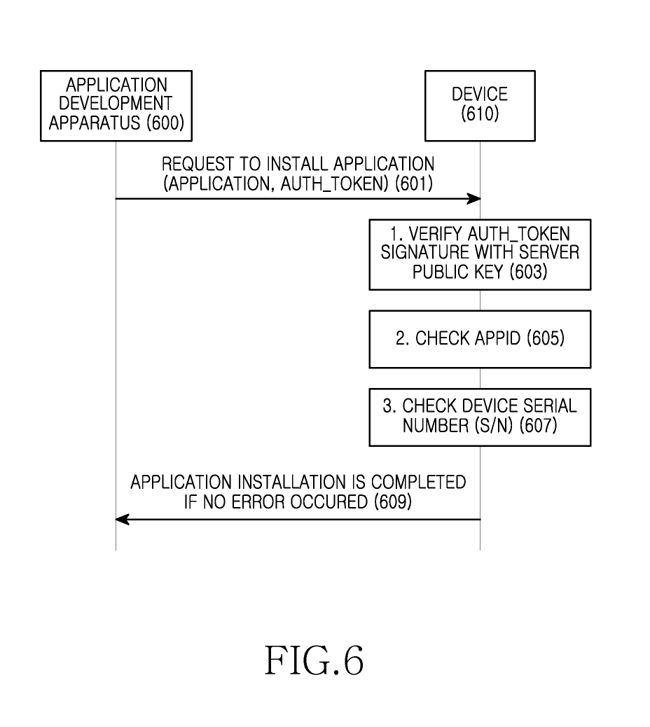

FIG. 6 illustrates a method for installing the application based on the authentication token in the device according to the present invention.

Referring to FIG. 6, the application development apparatus 110 requests to install the application by sending the application and the authentication token to the device 100 in step 601.

The device 100 receiving the application installation request verifies the signature in the authentication token by comparing the value generated based on a server public key with the signature of the authentication token in step 603. The device 100 checks the application identifier in the authentication token by comparing the application identifier of the authentication token with the application identifier of the application execution file constituting the application in step 605, and checks the device serial number in the authentication token by comparing the device serial number of the authentication token with its serial number in step 607.

Upon successfully verifying the signature, the application identifier, and the device serial number in the authentication token, the device 100 installs the application and informs the application development apparatus 110 of the application installation completion in step 609. Although it is not illustrated in FIG. 6, when the signature, the application identifier, and the device serial number in the authentication token are not successfully verified, the device 100 can inform the application development apparatus 110 of the application installation failure.

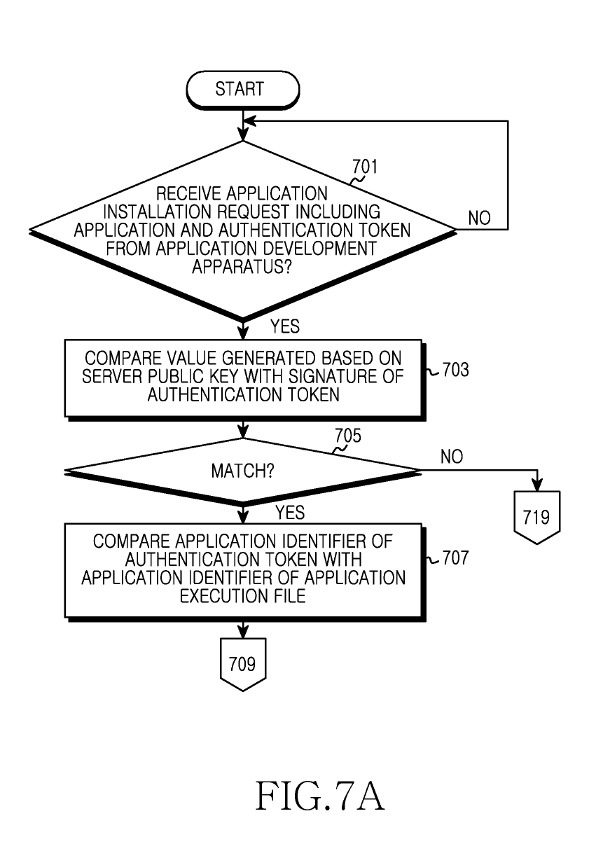

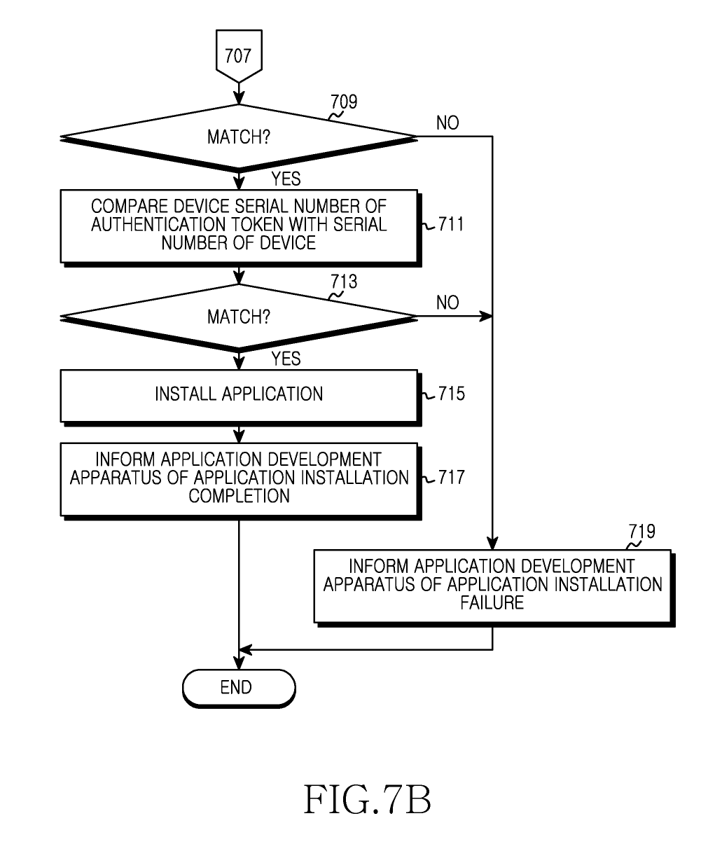

FIG. 7 illustrates a method of the device for installing the application based on the authentication token according to the present invention.

Referring to FIG. 7, the device determines whether the application installation request including the application and the authentication token is received from the application development apparatus in step 701.

Upon receiving the application installation request including the application and the authentication token from the application development apparatus in step 701, the device compares the value generated based on the server public key with the signature of the authentication token in step 703, and determines whether the value generated based on the server public key and the signature of the authentication token match (i.e., are the same) in step 705.

When the value generated based on the server public key and the signature of the authentication token match in step 705, the device compares the application identifier of the authentication token with the application identifier of the application execution file constituting the application in step 707, and determines whether the application identifier of the authentication token and the application identifier of the application execution file constituting the application match in step 709. This step is performed to prevent the user from arbitrarily installing the application downloaded from an App Store.

When the application identifier of the authentication token and the application identifier of the application execution file constituting the application match in step 709, the device compares the device serial number of the authentication token and its serial number to verify whether the device itself is authorized for the application in step 711, and determines whether the device serial number of the authentication token and its serial number match in step 713.

When the device serial number of the authentication token and its serial number match in step 713, the device installs the application in step 715 and informs the application development apparatus of the application installation completion in step 717.

By contrast, when the value generated based on the server public key and the signature of the authentication token do not match in step 705, when the application identifier of the authentication token and the application identifier of the application execution file constituting the application do not match in step 709, or when the device serial number of the authentication token and its serial number do not match in step 713, the device informs the application development apparatus of the application installation failure in step 719.

Next, the device finishes this process.

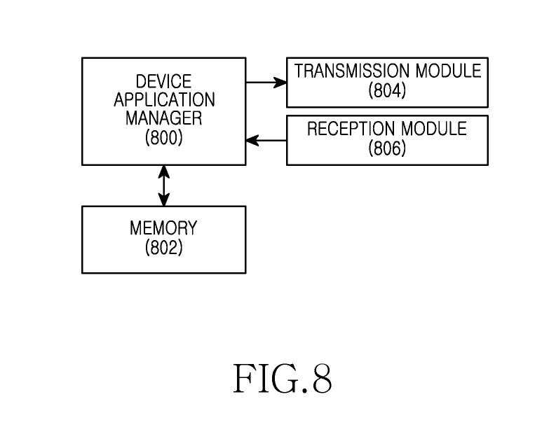

FIG. 8 illustrates the device (or the application development apparatus or the development server) according to the present invention. Herein, the device, the application development apparatus, or the development server includes the same block structure.

The apparatus includes a device application manager 800, a memory 802, a transmission module 804, and a reception module 806 as shown in FIG. 8.

The device application manager 800 installs and executes the corresponding application based on the application and the authentication token provided from the application development apparatus. The device application manager 800 verifies the signature, the application identifier, and the device serial number in the authentication token, and installs the corresponding application only when the verification is successfully completed.

The memory 802 stores the received application and authentication token.

The transmission module 804 provides information or a message from the device application manager 800 to the application development apparatus.

The reception module 806 provides information or a message received from the application development apparatus, to the device application manager 800.

As for the application development apparatus, the device application manager 800 registers the serial number list of the devices authorized for the application for the device, to the development server, and downloads the authentication token generated based on the list and the application execution file, from the development server. The device application manager 800 generates the application based on the downloaded authentication token and application execution file, and provides the generated application and the authentication token to the device to control to install the application.

The memory 802 stores the downloaded authentication token and application execution file.

The transmission module 804 provides information or a message from the device application manager 800 to the device or the development server.

The reception module 806 provides information or a message received from the device or the development server, to the device application manager 800.

As for the development server, the device application manager 800 registers the serial number list of the devices authorized for the application for the device according to the request of the application development apparatus, generates the authentication token based on the list and the application execution file required to install the application for the device, and provides the generated authentication token and application execution file to the application development apparatus.

The memory 802 maps and stores the application identifier, the application profile, the system requirement, and the device serial number list, per the registered application for the device.

The transmission module 804 provides information or a message from the device application manager 800 to the application development apparatus.

The reception module 806 provides information or a message received from the application development apparatus to the device application manager 800.

In the application development system, the application development apparatus registers the device serial number list authorized for the application for the device, to the development server, which generates and transmits the authentication token based on the list and the application execution file, and the authorized device installs the application based on the authentication token. Therefore, only the device authorized for the application for the device can install the corresponding application, and thus the illegal copies of the application can be prevented. For example, when the user develops the application and registers it to an App Store at a cost, it is possible to block a user downloading the corresponding application from distributing the application without permission through the IDE. In addition, the user can designate the device to test his/her application developed using the application development apparatus, block his/her application from leaking in the phase of the development, and simultaneously execute multiple applications, to thereby easily perform the application test.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An operating method of a device for installing an application for a device, comprising:
receiving an application installation request including an application and an authentication token from an application development apparatus; and
installing the application based on the authentication token,
wherein the authentication token includes serial numbers of devices authorized for the application.

2. The operating method of claim 1, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

3. The operating method of claim 1, wherein installing the application comprises:
determining whether a value generated based on a server public key and a signature of the authentication token match;
determining, when the value generated based on the server public key and the signature of the authentication token match, whether an application identifier of the authentication token and an application identifier of an application execution file constituting the application match;
determining, when the application identifier of the authentication token and the application identifier of the application execution file constituting the application match, whether a device serial number of the authentication token and a serial number of the device match; and
installing the application, when the device serial number of the authentication token and the serial number of the device match.

4. An operating method of an application development apparatus for installing an application for a device, comprising:
transmitting, to a development server, a serial number list of devices authorized for an application;
downloading, from the development server, an authentication token generated based on the device serial number list; and
transmitting, to a device, an application installation request including the downloaded authentication token and an application.

5. The operating method of claim 4, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

6. The operating method of claim 4, further comprising:
logging in to the development server by transmitting an identifier and a password to the development server; and
transmitting, to the development server, a registration request comprising a profile of an application to generate and a system requirement.

7. The operating method of claim 6, further comprising:
downloading, from the development server, an application execution file including an application identifier generated by the development server and an application profile; and
generating the application based on the downloaded application execution file and authentication token.

8. The operating method of claim 4, further comprising:
determining whether devices authorized for the application are modified;
transmitting, when the devices authorized for the application are modified, the application identifier and a modified device serial number list to the development server; and
downloading from the development server a new authentication token generated based on the modified device serial number list.

9. An operating method of a development server for installing an application for a device, comprising:
receiving, from an application development apparatus, a serial number list of devices authorized for an application;
generating an authentication token based on the device serial number list; and
transmitting the generated authentication token to the application development apparatus.

10. The operating method of claim 9, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

11. The operating method of claim 9, further comprising:
processing login of the application development apparatus by receiving an identifier and a password from the application development apparatus;
receiving, from the application development apparatus, a registration request comprising a profile of an application to generate and a system requirement;
generating a unique application identifier, and mapping and registering the generated application identifier with the application profile and the system requirement; and
generating and transmitting an application execution file including the application identifier and the application profile to the application development apparatus.

12. The operating method of claim 9, further comprising:
receiving an application identifier and a modified device serial number list from the application development apparatus;
generating a new authentication token based on the modified device serial number list; and
transmitting the generated new authentication token to the application development apparatus.

13. A device for installing an application for a device, comprising:
a reception module for receiving, from an application development apparatus, an application installation request including an application and an authentication token; and
a device application manager for installing the application based on the authentication token,
wherein the authentication token includes serial numbers of devices authorized for the application.

14. The device of claim 13, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

15. The device of claim 13, wherein the device application manager determines whether a value generated based on a server public key and a signature of the authentication token match, determines whether an application identifier of the authentication token and an application identifier of an application execution file constituting the application match when the value generated based on the server public key and the signature of the authentication token match, determines whether a device serial number of the authentication token and a serial number of the device match when the application identifier of the authentication token and the application identifier of the application execution file constituting the application match, and installs the application when the device serial number of the authentication token and the serial number of the device match.

16. An application development apparatus for installing an application for a device, comprising:
a transmission module for transmitting, to a development server, a serial number list of devices authorized for an application; and
a device application manager for downloading, from the development server, an authentication token generated based on the device serial number list,
wherein the transmission module transmits an application installation request including the downloaded authentication token and an application, to a device.

17. The application development apparatus of claim 16, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

18. The application development apparatus of claim 16, wherein the transmission module logs in to the development server by transmitting an identifier and a password to the development server, and transmits a registration request comprising a profile of an application to generate and a system requirement, to the development server.

19. The application development apparatus of claim 18, wherein the device application manager downloads, from the development server, an application execution file including an application identifier generated by the development server and an application profile, and generates the application based on the downloaded application execution file and authentication token.

20. The application development apparatus of claim 16, wherein the device application manager determines whether devices authorized for the application are modified, and
when the devices authorized for the application are modified, the transmission module transmits the application identifier and a modified device serial number list to the development server,
wherein the device application manager downloads a new authentication token generated based on the modified device serial number list from the development server.

21. A development server for installing an application for a device, comprising:
a reception module for receiving from an application development apparatus a serial number list of devices authorized for an application;
a device application manager for generating an authentication token based on the device serial number list; and
a transmission module for transmitting the generated authentication token to the application development apparatus.

22. The development server of claim 21, wherein the authentication token comprises at least one of an application identifier field for identifying the application, a device number field indicating the number of the devices authorized for the application, a device serial number field indicating the serial number list of the devices authorized for the application, a signature field of a development server, and a certificate chain field for signature verification.

23. The development server of claim 21, wherein the reception module processes login of the application development apparatus by receiving an identifier and a password from the application development apparatus, and receives a registration request comprising a profile of an application to generate and a system requirement, from the application development apparatus,
the device application manager generates a unique application identifier, maps and registers the generated application identifier with the application profile and the system requirement, and generates an application execution file including the application identifier and the application profile, and
the transmission module transmits the generated application execution file to the application development apparatus.

24. The development server of claim 21, wherein the reception module receives an application identifier and a modified device serial number list from the application development apparatus,
the device application manager generates a new authentication token based on the modified device serial number list, and
the transmission module transmits the generated new authentication token to the application development apparatus.
